(19) United States
(12) Patent Application Publication
(10) Pub. No.: US 2005/0194214 A1
(43) Pub. Date: Sep. 8, 2005

(54) Retractable stabilizer supports for stepladders

(76) Inventor: Martin L. Royce, Northfield, IL (US)

Correspondence Address: VEDDER PRICE KAUFMAN & KAMMHOLZ, 222 N. LASALLE STREET, CHICAGO, IL, 60601, US

(21) Appl. No.: 10/794,202

(22) Filed: Mar. 5, 2004

(51) Int. Cl. E06C 1/00

(52) U.S. Cl. 182/172

(57) ABSTRACT

An apparatus and method is disclosed that utilizes a retractable stabilizer support that is attached to a rail of a stepladder to provide lateral support to the stepladder. The retractable stabilizer support includes a footing and a pivot mount. The pivot mount is mountable to the stepladder rail such that the footing can be pivoted from an extended position to a retracted position. In the extended position, the footing extends along its footing length rigidly laterally outward away from the stepladder rail and substantially adjacent to the base surface. In the retracted position, the footing extends along its footing length away from the base end of the stepladder rail and substantially adjacent to the stepladder rail.

### BACKGROUND OF THE INVENTION

1. Field of the Invention

The invention relates generally to an apparatus and method for introducing lateral stabilizer supports to stepladders. More particularly, the invention relates to an apparatus and method for providing lateral support to stepladders by utilizing stabilizer supports that extend outwardly from the sides of their rails.

2. Description of Related Art

Typically, stepladders are characterized by having broad flat rungs (steps) and two pairs of rails (legs) connected by a hinge at the top such that the ladder opens at the bottom to become freestanding. Generally, such ladders contain three or more rails, can stand alone, and have at least one step for supporting a person thereon.

Stepladders generally have three distinct configurations: closed, open and transitional. In the closed configuration a pair of transversely positionable rails are folded or positioned into a longitudinal adjacent alignment. It is in this closed position that the ladder can be easily transported and/or stored. In the open configuration the pair of transversely positionable rails are extended away from one another, in a transverse manner, such that the base of each of the stepladder rails rest upon a base surface such that the stepladder is freestanding. The transitional configuration occurs during a transition between open and closed positions where the stepladder is either in the process of being folded (for storage or transport) or unfolded (for use). It should be noted, however, that some rare stepladders are not collapsible, and as such, have only an open configuration (i.e., the ladder cannot be folded up for storage).

As configured, stepladders are potentially unstable in two linear directions, such directions being perpendicular to each other. One of the linear directions is a lateral direction, i.e., running parallel to the rungs on the ladder. The other linear direction is forward-and-back, i.e., running perpendicular to the rungs or along the direction in which the stepladder opens.

Typically, stepladders include different means for stabilization with respect to the lateral and forward-and-back directions. In the forward-and-back direction, a hinge-locking mechanism is often used such that the ladder always opens to a precisely defined angle. In such designs, the ladders can be pre-designed to open to an optimum angle where the forward-and-back stability is optimal. In any case, it is typically the width at which the legs of the rails separate when the stepladder is opened that determines the forward-and-back stability of the stepladder. Stability in the lateral direction is typically provided by the base width of the rails containing the ladder rungs. Therefore, typically the wider the stepladder base, the more stable the stepladder is in the lateral direction. Since it is the base of the stepladder that matters, many designs contain a broadened base while having a narrow top. However, wider stepladders, even when just the base is wide, introduce drawbacks such as additional weight and wider storage requirements that affect the ability to transport and store such ladders.

In one stepladder design, it is not just the width between the rails that provides all of the lateral stability, but also includes the use of adjustable stabilizer poles that extend laterally outward from the top of the ladder. Such stabilizer poles are pivotally attached to an external cross member that is located at the apex of the stepladder. The external cross member is wider than the top of the ladder and contains pivoting attachment points that are laterally away from the outer edges of the top of the ladder. The stabilizer poles, attached to the pivoting attachment points, extend downward and laterally outward from the external cross member until they meet the base surface on which the stepladder rests. The pivot attachment points are located near (within several inches) the outside of the upper portion of a corresponding opposing pair made up of one rung rail and one transverse rail. The design requires a stabilizer pole that is at least as long as the stepladder's apex is high.

Another design increases the stepladder's lateral stability by using a one-size-fits-all stepladder pad. In this design, the base portions of the stepladder rails are placed into holes of the stepladder pad such that the outer sides of the stepladder pad extend outwardly, away from both of the rails containing the ladder rungs. The distance at which the stepladder sides extend laterally away from the sides of the stepladder is a distance that is less than one tenth the height of the corresponding rails. The stepladder pad is designed to be easily removed and placed on stepladders of varying designs and widths. Unless the stepladder pad is removed after use, the width of the base of the ladder remains the width of the stepladder pad. As such, to reduce the width of the stepladder to its pre-stepladder pad width, the stepladder pad must be removed. Therefore, the storage or transport requires the transport or storage of multiple separate parts.

Another stepladder design uses a complicated adjustable multi-bracketed transverse rail pair design. Here not only can the transverse rail pair be opened to provide stability in the forward-and-back direction, but, the opposing transverse rail pair (i.e., the pair opposing the pair of rails containing the ladder rungs) may be extended apart laterally to expand the pair's base width. This capability to expand the base of the transverse rail pair has numerous features including: (1) a left pivoting point to allow the outward lateral rotation of the left transverse rail, (2) a right pivoting point to allow the outward lateral rotation of the right transverse rail, (3) six collapsible upper bracket pieces along with their six corresponding nut and bolt pieces, and (4) four collapsible lower bracket pieces along with their six corresponding nut and bolt pieces. In this design, it is the adjustable opposing transverse rails that provide the additional lateral stability. Although the expandable base of the transverse rail pair provides additional lateral stability, it does so at the higher expense of designing and manufacturing such a complicated multi-part device. Further, this design is not compatible with pre-existing ladder designs absent a laterally adjustable transverse rail pair width.

Another design includes the use of pads which are attached to the bottom of stepladder rails to help prevent the rails from sinking into a soft base surface or from sliding across the base surface. Such pads are generally described as preventing sinkage or slippage of the ladder rails, without suggesting any advantage of increased lateral stability. In addition, the pads are described and shown to extend laterally only a marginal distance (i.e., approximately two inches). Unless the pads are removed after use, the width of the base of the transverse rail pair remains at the width of the transverse rail pair plus the additional lateral width each pad adds to each transverse rail. As such, to reduce the width of the stepladder to its pre-pad width, the stepladder pads must be removed. Therefore, the storage or transport requires the transport or storage of multiple separate parts.

It should be understood that the stability of stepladders, in relation to the stability provided by where the rails of the ladder meet the base surface, is more important than the same base surface-related stability associated with straight or standard ladders. This is true because the stability of stepladders is solely dependent upon the interaction of the stepladder's legs with the base surface, while in contrast, standard ladders receive additional stability at the locations where such standard ladders contact the object on which such ladders rest. As such, the inherent design differences between the two types of ladders means that the stepladder relies more heavily, and in fact, relies solely on the stability provided between the rails of the ladder and the base surface.

As demonstrated above, a need exists for a stepladder design that provides added stability while maintaining a relatively narrow rail-to-rail dimension along its entire length. Desirably, the stepladder would include the functionality of a narrow rail-to-rail base in the closed position while also having a wide rail-to-rail base in the open position, wherein such functionality is provided at minimum cost, with minimum parts, with minimum weight and which, ideally, is capable of being retrofitted to a variety of pre-existing stepladder designs.

### BRIEF SUMMARY OF THE INVENTION

One embodiment of the invention is a stepladder having a pivoted footing. Such stepladder has a first rail and a second rail each having a base end and a bottom wherein at least one rung extends between the first and the second rail. The stepladder also has at least one transverse rail having a base end and a bottom and is positioned transversely to the first and second rails to support the first and second rails in the climbing configuration. The stepladder has at least one footing, wherein such footing has a footing length and the footing is pivotally attached to the bottom of an associated rail. In addition, the footing has an extended position wherein the footing extends along its footing length rigidly laterally outward away from the first rail and the second rail, and substantially adjacent to the base surface.

Another embodiment of the invention is a retractable stabilizer support for attachment to a rail of a stepladder where the retractable stabilizer support provides lateral support to the stepladder. The stepladder rail includes a base end that rests on a base surface. The retractable stabilizer support includes a footing including having a footing length. The retractable stabilizer support also includes a pivot mount wherein the pivot mount is mountable to the stepladder rail such that the footing can be pivoted from an extended position to a retracted position. The extended position is where the footing extends along its footing length rigidly laterally outward away from the stepladder rail and substantially adjacent to the base surface. The retracted position is where the footing extends along its footing length away from the base end of the associated rail and substantially adjacent to the associated rail.

An additional embodiment of the invention is a retractable stabilizer support for attachment to a rail of a stepladder for providing lateral support to the stepladder. The stepladder rail has a base end that rests on a base surface. The retractable stabilizer support includes a footing having a footing length and a pivot mount. The pivot mount is mountable to the stepladder rail such that the footing can be pivoted from an extended position to a retracted position. In the extended position, the footing extends along its footing length rigidly laterally outward away from the stepladder rail and substantially adjacent to the base surface. In the retracted position, the footing extends along its footing length away from the base end of the stepladder rail and substantially adjacent to the stepladder rail.

Yet another embodiment of the invention is a method of stabilizing a stepladder, the stepladder having a first rail and a second rail, each rail having a base end and a bottom. A rung extends in a lateral direction between the first and second rails. A transverse rail has a base end and a bottom is positioned transversely to the first and second rail to support the first and second rail in a climbing configuration. The ladder also has a footing having a footing length. The footing is pivotally attached to a base end of an associated rail. The stepladder is in a climbing configuration resting on a base surface. The method includes the steps of: rotating the footing, along its footing length, from a position substantially adjacent to the associated rail to a position extending laterally outward from the side of the associated rail substantially adjacent to the base surface. The method also includes the locking of the footing in the position extending laterally outward from the side of the associated rail substantially adjacent to the base surface by fixedly securing the brace assembly between the footing and the associated rail.

### BRIEF DESCRIPTION OF THE SEVERAL VIEWS OF THE DRAWINGS

The invention will be more readily understood with reference to the following drawings wherein like reference numbers represent like elements and wherein:

FIG. 1 is a perspective view of a stepladder with the retractable stabilizer supports in an extended position wherein the footings extend rigidly laterally outward away from first and second rails substantially adjacent to the base surface, in accordance with one embodiment of the invention;

FIG. 2 is a perspective view of a stepladder with the retractable stabilizer supports in a retracted position wherein the footings extend away from the base ends of the associated rails and substantially adjacent to the associated rails, in accordance with one embodiment of the invention;

FIG. 3 is a side elevational view of a footing of the retractable stabilizer support, in accordance with one embodiment of the invention;

FIG. 4 is a top view of a footing of the retractable stabilizer support, in accordance with one embodiment of the invention;

FIG. 5 is a side view of a bracing bracket of the retractable stabilizer support, in accordance with one embodiment of the invention;

FIG. 6 is a second side view of a bracing bracket of the retractable stabilizer support taken along line 6-6 of FIG. 5, in accordance with one embodiment of the invention;

FIG. 7 is an edge-on view of a securing bracket of the retractable stabilizer support, in accordance with one embodiment of the invention;

FIG. 8 is a view of a securing bracket of the retractable stabilizer support taken along line 8-8 of FIG. 7, in accordance with one embodiment of the invention;

FIG. 9 is a truncated side view of a bracket member, in accordance with one embodiment of the invention; and

FIG. 10 is a method for stabilizing a stepladder by utilizing a footing that extends laterally outward from the side of the stepladder.

### DETAILED DESCRIPTION OF THE INVENTION

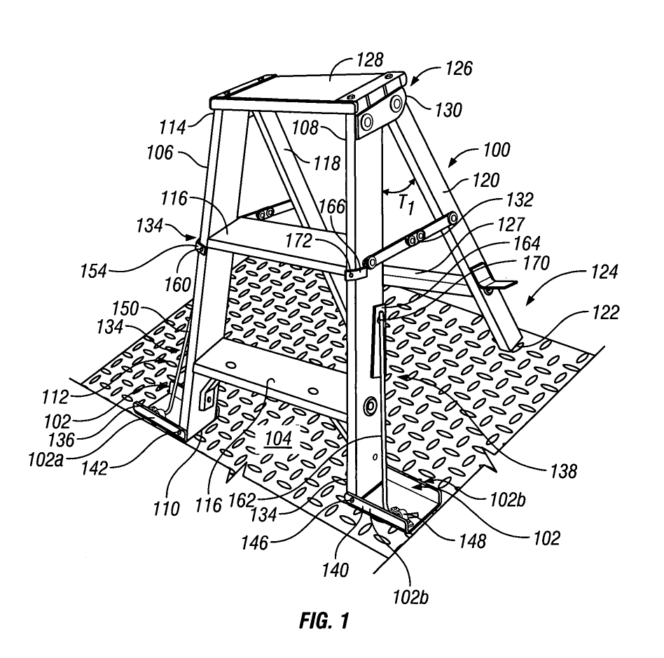

One embodiment of the invention is shown in FIG. 1 and includes a stepladder 100 with retractable stabilizer supports 102 and a base surface 104. As shown, the stepladder 100 is positioned in a climbing configuration, ready for a user to ascend along its height, and the retractable stabilizer supports 102 are in an extended position that provides greater lateral stability to the stepladder. The stepladder 100 further includes a first rail 106 and a second rail 108. Both the first and second rail each have a base end 110, a bottom 112 and a top-end 114. Between the first and second rail are rungs 116. Extending at a transverse angle T₁ to the first rail 106 is transverse rail 118. Extending at the same transverse angle T₁ to the second rail 108 is transverse rail 120. Each transverse rail 118 and 120 has a base end 122, a bottom 124 and a top-end 126. Extending between the two transverse rails 118 and 120 is stabilizer member 127.

At the top of the ladder is an apex shelf 128. Connecting the apex shelf 128 to the set of first and second rails 106 and 108 to the set of transverse rails 118 and 120 is apex bracket 130. The connections between the apex bracket 130 and both the set of first and second rails 106 and 108 and the set of transverse rails 118 and 120 are rotatable or pivot connections allowing such sets of rails to pivot with respect to one another and the apex shelf 128 such that the position of the set of transverse rails 118 and 120 are positioned transversely to the set of first and second rails 106 and 108 at transverse angle T₁ when the stepladder is in the climbing configuration. The transverse angle T₁ is maintained between the set of transverse rails 118 and 120 and the set of first and second rails 106 and 108 via locking hinge bracket 132.

Although in the above-described embodiment the stepladder 100 has the specific components discussed, other stepladder embodiments having different components may be used in conjunction retractable stabilizer supports 102 without departing from the present invention. For example, other embodiments include stepladders having more or fewer steps or rungs 116 than the two shown. Other embodiments utilize a single transverse rail while others use three or more transverse rails. In addition, other embodiments do not have the top-ends of first and second rails meeting at or near the top-ends of corresponding transverse rails, for example, some embodiments include the transverse rails meeting the first and second rails between the middle and the top of the first and second rails. It is contemplated that most, if not all, stepladder designs available could be utilized with the present invention.

As shown, the retractable stabilizer supports 102 include both a first retractable stabilizer support 102a and a second retractable stabilizer support 102b. The retractable stabilizer supports 102 are shown in their extended position such that the base of stepladder 100 is expanded beyond the width of the base ends of the stepladder 100 to provide additional lateral stability to stepladder 100. The first retractable stabilizer support 102a further includes a first brace assembly 134 and a first footing 136. (Also see the description of the second retractable stabilizer support 102b below.)

The first brace assembly 134 includes a first brace member 150, a first bracing bracket (not shown) and the first securing bracket 154. The first brace member 150 is formed in an “L” shape to engage the first footing 136 between the first clasp member (not shown) and the top surface (not shown) of the first footing 136. The first bracing bracket includes attachment apertures (not shown) used to secure the first bracing bracket (not shown) to the first rail 106, and a brace-receiving aperture to receive the end of first brace member 150 when the first footing 136 is in the extended position. The first securing bracket 154 contains an attachment aperture 160 used to secure the first securing bracket 154 to the first rail 106 and compression material (not shown) lining the inside of the first securing bracket 154 to assist in receiving the first brace member 150 between the first securing bracket 154 and the side of the first rail 106. As shown, the first brace assembly 134 is in the extended position where the first brace member 150 is engaged with the first bracing bracket such that the first footing 136 extends rigidly laterally outwardly away from the first rail 106 and the second rail 108 and substantially adjacent to the base surface 104.

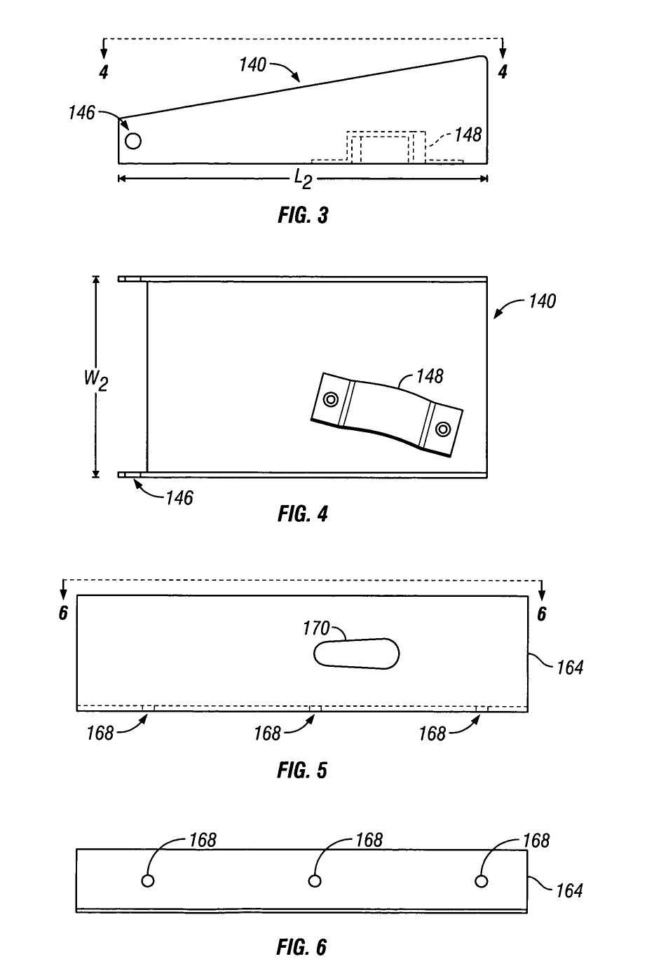

The first footing 136, (also see FIGS. 3 and 4) includes a first footing length L₁, a first footing width W₁, first pivot mount 142 and a first clasp member (not shown). As shown, the first footing 136 is in the extended position where the first footing length L₁ is pivoted outward about the first pivot mount 142 such that the first brace member 150 is engaged with the first bracing bracket such that the first footing 136 extends along its first footing length L₁ rigidly laterally outwardly away from the first rail 106 and the second rail 108, and substantially adjacent to the base surface 104. In this position the first bracing bracket maintains a force upon the first footing 136 through the first clasp member to maintain its rigidly laterally outward position when in contact with the base surface 104 even when a load is placed on the stepladder 100.

The second retractable stabilizer support 102b includes a second brace assembly 138 and a second footing 140. The second brace assembly 138 includes a second brace member 162, a second bracing bracket 164 and a second securing bracket 166. The second brace member 162 is formed in an “L” shape to engage the second footing 140 between the second clasp member 148 and the top surface of the second footing 140. The second bracing bracket 164 includes attachment apertures (not shown) used to secure the second bracing bracket 164 to the second rail 108, and a brace receiving aperture 170 to receive the end of second brace member 162 when the second footing 140 is in the extended position. The second securing bracket 166 has an attachment aperture 172 used to secure the second securing bracket 166 to the second rail 108 and compression material (not shown) lining the inside of the second securing bracket 164 to assist in receiving the second brace member 162 between the second securing bracket 166 and the side of the second rail 108. As shown, the second brace assembly 138 is in the extended position where the second brace member 162 is engaged with the second bracing bracket 164 such that the second footing 140 extends rigidly laterally outwardly away from the first rail 106 and the second rail 108 and substantially adjacent to the base surface 104.

The second footing 140 includes a second footing length L₂, a second footing width W₂, second pivot mount 146 and a second clasp member 148. As shown, the second footing 140 is in the extended position where the second footing length L₂ is pivoted outward about the second pivot mount 146 such that the second brace member 162 is engaged with the second bracing bracket 164 such that the second footing 140 extends along its second footing length L₂ rigidly laterally outwardly away from the first rail 106 and the second rail 108 and substantially adjacent to the base surface 104. In this position the second bracing bracket 164 maintains a force upon the second footing 140 through the second clasp member 148 to maintain its rigidly laterally outward position when in contact with the base surface 104 even when a load is placed on the stepladder 100.

The base surface 104 is a floor, ground or other planar-like surface on which the stepladder 100 is placed. The interaction between the retractable stabilizer supports 102 and the base surface 104 provides added lateral stability to stepladder 100. Further, to the extent that the first footing 136 and the second footing 140 provide a wider footprint than the corresponding base ends 110 of first and second rails 106 and 108, such wider footprint also provides added stability that is particularly advantageous where the base surface 104 is relatively soft. The wider footprint restricts the base end 110 of the corresponding rail from sinking as far into the base surface 104 than if the footprint were simply that of the base end 110 itself.

Other embodiments of the retractable stabilizer supports 102 also fall within the present invention. For example, other embodiments utilize retractable stabilizer supports 102 on only one of two rails having one or more rungs 116. Further, other embodiments locate such retractable stabilizer supports 102 on one or more of the transverse rails. What is common to most embodiments is that when the retractable stabilizer support(s) are transitioned to the extended position, the base of the stepladder 100 is increased in the lateral direction to provide greater lateral stability for the stepladder 100.

In addition, other embodiments use brace assemblies 134 and 136 that have different brace members 150 and 162, bracing bracket 164 and/or securing brackets 154 and 166, and/or omit one or more thereof. For example, other embodiments use brace members 150 and 162 that are not in the form of a cylindrical bar, but rather a triangle, rectangle or other shapes having planar sides or other suitable shapes. In addition, other brace members 150 and 162 do not rotate at the footings 136 and 140, but rather rotate along the corresponding rails 106 and 108, for example, a right triangular-shaped brace member which has a hinge along its vertical perpendicular side rotates along the length of the associated rails 106 and 108 such that the triangle's base swings out along the length of the footing length and attaches to such footings 136 and 140. What is common with most embodiments is that the base member forms a removable support between the footings 136 and 140 and the associated rails 106 and 108 to selectively provide support to keep the footings 136 and 140 extending rigidly laterally away from the side of the corresponding rails 106 and 108.

Also, other embodiments use bracing bracket 164 with multiple receiving apertures 170 to receive and support corresponding brace members 150 and 162 such that different angles between the corresponding footings 136 and 140 and the surface base 104 are achieved. In addition, another bracing bracket 164 is located toward the front edge of the corresponding rails 106 and 108 rather than toward the back edge as shown in FIG. 1. Further, other embodiments do not use apertures to receive an end of a corresponding bracing bracket 164, but rather include members that extend outward to connect to such bracing bracket 164. Yet other embodiments do not use the bracing bracket 164 at all but rather apertures or extending members on the rail itself provide the functionality that provides the upper support for the corresponding brace member. In other embodiments, the bracing bracket 164 and the securing brackets 154 and 166 are the same component. What is common in most embodiments that utilize a bracing bracket 164, or something to receive a portion of brace members 150 and 162, is that some form of aperture or extending member is built in or attached to the corresponding side rails 106 and 108 to secure an end of the corresponding brace members 150 and 162.

Some embodiments mount the securing brackets 154 and 166 on the side of a corresponding rail rather than at the front of the rails 106 and 108 as shown in FIG. 1. Further, other embodiments that use a single component for both the bracing bracket 164 and securing brackets 154 and 166 bracket utilize friction about the brace members 150 and 162 such that the footings 136 and 140 can be stopped at any angle, or at least at a retracted position. In another embodiment, the securing brackets 154 and 166 directly contact the footings 136 and 140 to secure the footing in a retracted state. What is common in most embodiments that utilize securing brackets 154 and 166 is that they act to secure the footing members 136 and 140 at or towards the side of the corresponding rails 106 and 108, whether acting directly upon the footing members 136 and 140 or indirectly through brace members 150 and 162 or other suitable component.

In addition, some embodiments use one or more footings 136 and 140 on one or more rails 106, 108, 118 and 120. Although the footings 136 and 140 in the embodiment shown in FIG. 1, show footings 136 and 140 with a particular length, width, height and shape, other embodiments utilize footings 136 and 140 that have different measurements and characteristics. For example, other embodiments have footings 136 and 140 that extend further in the lateral direction for stepladders of the same or different heights. Other embodiments use footings 136 and 140 of a width that is less than the side width of the corresponding rails 106 and 108. Other embodiments use footings 136 and 140 that contact only the base surface 104 at a distance away from the base end 110 of the corresponding rails 106 and 108. Yet other embodiments utilize footings 136 and 140 that pivot from the face of the side rails 106 and 108 rather than from the front. Other embodiments pivot the footings 136 and 140 from both the front and back of the rails 106 and 108. Some embodiments pivot the footings 136 and 140 from a distance above the base end 110 of the corresponding rails 106 and 108. What is common with most embodiments is that the footings 136 and 140 are pivotally attached at the bottom of the corresponding rails 106 and 108 and where footings 136 and 140 may be selectively positioned to extend rigidly laterally outwardly away from corresponding rails 106 and 108.

In another embodiment, when in the extended position, the footings 136 and 140 extend at an approximate five-degree angle away from the base surface 104. In another embodiment, the footings 136 and 140, when in the extended position, extend at an approximately five-degree angle from the base surface 104. What is common with most embodiments is that the angle at which the footings 136 and 140 extend away or towards the base surface (whether zero degrees, five degrees, or another angle), is that the footings 136 and 140 act to prevent or reduce the stepladder 100 from tilting and/or falling to one side or the other. As such, the term “substantially adjacent to” as used in connection with “the base surface” is intended to include footings 136 and 140 that are offset from the base surface 104, up or down, at angles up to approximately 20 degrees.

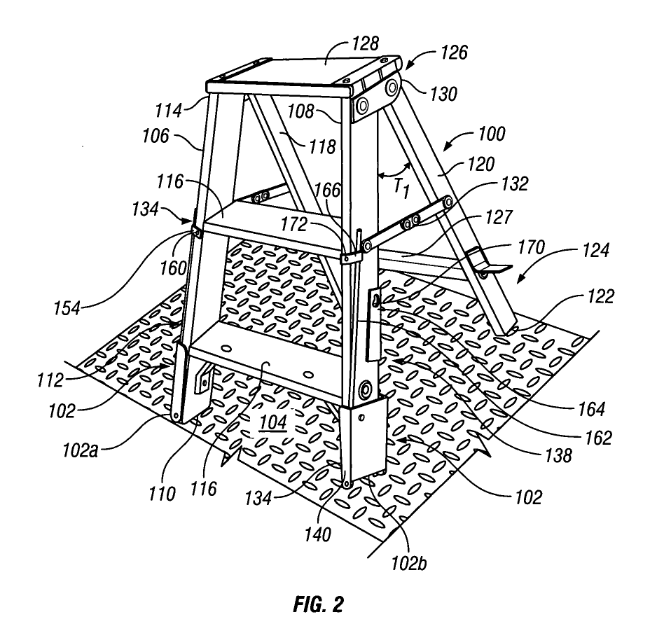

FIG. 2, like FIG. 1, shows the stepladder 100 positioned in a climbing configuration. However, in FIG. 2, the retractable stabilizer supports 102 are in a retracted position that allows for easy transport and storage of the stepladder 100. In the retracted position, the retractable stabilizer supports 102 are retracted such that the base of stepladder 100 is equal to the span between and including the first and second rails 106 and 108.

More specifically, the first brace assembly 134 is shown in the retracted position such that the first brace member 150 is engaged with the first securing bracket 154 such that the first footing 136 extends away from the base end 110 of the first rail 106 and substantially non-adjacent to the base surface 104. In addition, the first footing 136 is retracted such that the first footing length L₁ is pivoted about the first pivot mount 142 such that the first brace member 150 is engaged with the first bracing bracket 164 such that the first footing 136 extends along its first footing length L₁ away from the base end 110 of the first rail 106 and substantially non-adjacent to the base surface 104. Further, as shown, the first footing 136 extends its first footing length L₁ away from the base end 110 of the first rail 106 and substantially adjacent to the first rail 106. In this position the first bracing bracket 164 maintains a force upon the first footing 136 by way of the first clasp member to maintain its retracted position with the first footing 136 non-adjacent to the base surface and substantially adjacent to the first rail 106.

Similarly, the second brace assembly 138 is retracted such that the second brace member 162 is engaged with the second securing bracket 166 such that the second footing 140 extends away from the base end 110 of the second rail 108 and substantially non-adjacent to the base surface 104. In addition, the second footing 140 is retracted such that the second footing length L₂ is pivoted about the second pivot mount 146 such that the second brace member 162 is engaged with the second securing bracket 166 such that the second footing 140 extends along its second footing length L₂ away from the base end 110 of the second rail 108 and substantially non-adjacent to the base surface 104. Further, as shown, the second footing 140 extends its second footing length L₂ away from the base end 110 of the second rail 108 and substantially adjacent to the second rail 108. In this position, the second bracing bracket 166 maintains a force upon the second footing 140 through the second clasp member 148 to maintain its retracted position with the second footing 140 non-adjacent to the base surface and substantially adjacent to the second rail 108.

In the embodiment shown in FIG. 2, the term “substantially adjacent to” as used in the phrase “the footing extends along its footing length away from the base end of the stepladder rail and substantially adjacent to the stepladder rail,” is intended to indicate that the footing is located relatively close to the associated side rail and is not intended to indicate that it is immediately next thereto nor that nothing can lie between the footing and the rail. Rather, the term “substantially adjacent to” as used therein is meant to indicate the close placement of the footing relatively near and relatively alongside the associated rail.

FIG. 3 shows the second footing 140 with its length L₂, its second pivot mount 146, and its second clasp member 148 (shown in dashed lines). As visible in FIG. 3 (see also FIG. 4), the second clasp member 148 is mounted on an angle with respect to the length L₂ of the second footing 140. Such angle is used to assist the easy rotation of the second bracing bracket 164 therein.

FIG. 4 is a top view showing the width W₂ of the second footing 140.

FIG. 5 shows the second bracing bracket 164 with its attachment apertures 168, and a brace-receiving aperture 170. In this embodiment a single brace-receiving aperture 170 is used to receive the second brace member 162.

FIG. 6 shows the second bracing bracket 164 from a side view. In this embodiment screws are used in the attachment apertures 168 to secure the second bracing bracket 164 to the second rail 108.

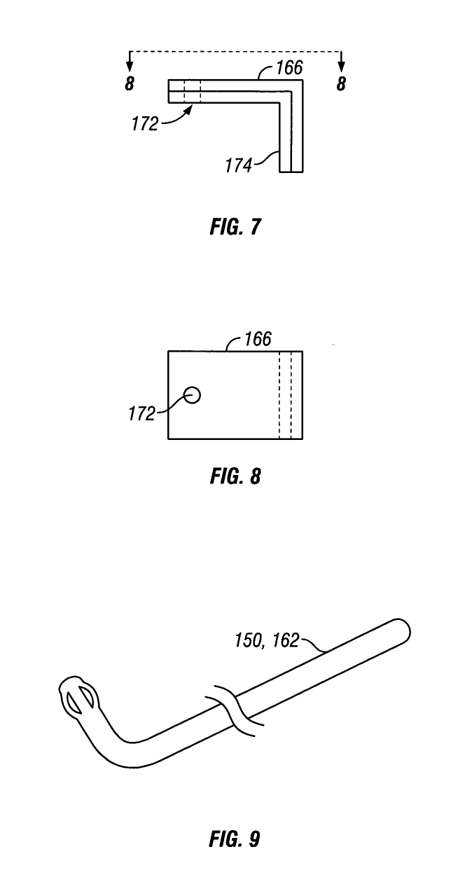

FIG. 7 shows the second securing bracket 166 with its attachment aperture 172 and compression material 174 lining the inside of the second securing bracket 164.

FIG. 8 shows another view of the securing bracket 166 where the circumference of attachment aperture 172 is clearly defined.

FIG. 9 shows the first and second brace members 105, 162. In this embodiment the brace members 105, 162 are bars that are “L” shaped. At the end of the bars are several protuberances about the outer circumference of the bar that are used to secure the bar within the second clasp member 148.

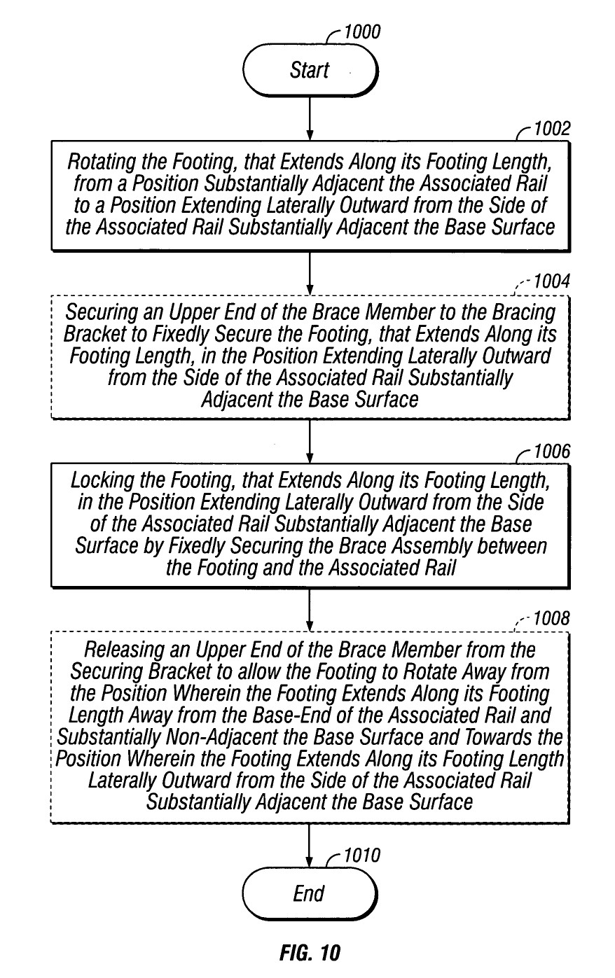

FIG. 10 shows a method for stabilizing a stepladder 100 by utilizing footings 136 and 140 that extend rigidly laterally outward from the side of the stepladder 100. The method begins with at the start node 1000 and ends at the end node 1010. After start node 1000 is step 1002 which includes rotating the footings 136 and 140, that extend along its footing length L₁, from a position substantially adjacent to the associated rails 106 and 108 to a position extending laterally outward from the side of the associated rails 106 and 108 substantially adjacent to the base surface 104. Following step 1002 is optional step 1004 that includes securing an upper end of the brace members 150 and 162 to the bracing bracket 164 to fixedly secure the footings 136 and 140, that extend along its footing length L₁, in the position extending rigidly laterally outward from the side of the associated rails 106 and 108 substantially adjacent to the base surface 104. Next, step 1004 includes locking the footings 136 and 140, that extend along its footing length L₁, in the position extending rigidly laterally outward from the side of the associated rails 106 and 108 substantially adjacent to the base surface 104 by fixedly securing the brace assemblies 134 and 138 between the footings 136 and 140 and the associated rails 106 and 108. Following step 1004 is step 1006 which includes releasing an upper end of the brace members 150 and 162 from the securing brackets 154 and 166 to allow the footings 136 and 140 to rotate away from the position wherein the footings 136 and 140 extend along its footing length L₁ away from the base end 110 of the associated rails 106 and 108 and substantially non-adjacent to the base surface 104 and toward the position wherein the footings 136 and 140 extend along its footing length L₁ laterally outward from the side of the associated rails 106 and 108 substantially adjacent to the base surface 104. Although, as shown in FIG. 10, a particular order of the identified steps, other embodiments perform the same steps in an alternate sequence.

In operation, and in accordance with one embodiment, the stepladder 100 initially has its first retractable stabilizer support 102a in the retracted position as shown in FIG. 2. In this retracted position, the first footing 136 extends along its footing length L₁ away from the base end 110 of the first rail 106 and substantially adjacent to the first rail 106. A user releases or disengages the upper end of the first brace member 150 from the first securing bracket 154 and, using the first brace member 150, urges the first footing 136 by rotating the first footing 136 along its footing length L₁ from a position substantially adjacent to the first rail 106 to a position extending rigidly laterally outward and away from the side of the first rail 106 to an intermediate position where the first footing 136 is in between being in the retracted position and the extended position. The user continues urging the first brace member 150 about its first pivot mount 142 until the first brace member 150 reaches the extended position where the first footing 136 extends along its footing length L₁ rigidly laterally outward from the first rail 106 substantially adjacent to the base surface 104. At such point, the user locks the first footing in such a position by fixedly securing the first brace assembly 134 between the between the first footing 136 and the first rail 106. This is performed by fixedly securing the upper end of the first brace member 150 within the brace-receiving aperture of the first bracing bracket. The user then performs the same series of steps on the corresponding right retractable stabilizer support 102b such that the second footing 140 extends along its footing length L₂ rigidly laterally outward from the second rail 108 adjacent to the base surface 104.

The embodiment shown in FIGS. 1 and 2 includes the use of at least one footing 136 (or footings 136 and 140) having a length and which is pivotally attached to the bottom of a rail or rails 106 and 108 of the ladder. As described herein, such footings 136 and 140 can be attached to any rails 106, 108, 118 and 120 of the ladder and extend along the footing length L rigidly laterally outwardly away from the associated rails 106 and 108. With such functionality, such embodiment provides the advantage of expanding the width of the stepladder 100 and thereby expanding the lateral stability of the stepladder 100. Further, where the footings 136 and 140 are pivotally attached to the bottom of rails 106 and 108, such embodiment also provides the advantage of selectively positioning the footings 136 and 140 in either an extended position, thus expanding the base of the stepladder 100 for use, or a retracted position, thus reducing the base size of the stepladder 100 for storage or transport, or other suitable usage.

Further, where the footings 136 and 140 can be fixedly positioned in either an extended position or a retracted position using the associated brackets, such embodiments provide the advantage of having adjustable footings 136 and 140 that can be set to a certain position and remain in such position until selectively modified. Such ability to fix the footings 136 and 140 in different positions provides both safety and convenience for the user. When fixed in the extended position, such embodiments provide the advantage of having a securely widened base that will remain in such position until the user is done using the stepladder 100. In addition, when fixed in a retracted position, such embodiments provide the advantage of having the footings 136 and 140 retracted at the side of the ladder, allowing for easy transport and storage where the width of the ladder is smaller.

While only a few embodiments and aspects of the invention have been described above, including the preferred embodiment, those of ordinary skill in the art will recognize that these embodiments and aspects may be modified and altered without departing from the central spirit and scope of the invention. Thus, the embodiments and aspects described above are to be considered in all respects as illustrative and not restrictive, the scope of the invention being indicated by the appended claims, rather than by the foregoing description, and all changes which come within the meaning and range of equivalency of the claims are intended to be embraced herein.

1. A stepladder, having a climbing configuration, wherein the stepladder rests on a base surface, and comprising:
at least a first rail and a second rail, each rail having a base end and a bottom;
at least one rung extending between the first rail and the second rail;
at least one transverse rail having a base end and a bottom and positioned transversely to the first rail and the second rail to support the first rail and the second rail in the climbing configuration; and
at least one footing having a footing length and pivotally attached to the bottom of an associated rail;
wherein the footing has an extended position wherein the footing extends along its footing length rigidly laterally outwardly away from the first rail and the second rail and substantially adjacent to the base surface.

2. The stepladder of claim 1, wherein the footing has a retracted position wherein the footing extends along its footing length away from the base end of the associated rail and substantially adjacent to the associated rail.

3. The stepladder of claim 1, further comprising a brace member wherein the brace member secures the footing in the rigidly laterally outward position substantially adjacent to the base surface.

4. The stepladder of claim 3, further comprising a bracing bracket anchored to the associated rail wherein one end of the brace member is fixedly attached to the bracing bracket and the other end of the brace member is fixedly attached to the footing to secure the footing in the rigidly laterally outward position substantially adjacent to the base surface.

5. The stepladder of claim 4, wherein the brace member is fixedly attached to the bracing bracket via an aperture in the bracing bracket.

6. The stepladder of claim 3, further comprising a securing bracket anchored to the associated rail wherein the securing bracket receives a portion of the brace member when the footing extends along its footing length away from the base end of the associated rail and is substantially non-adjacent to the base surface.

7. The stepladder of claim 3, wherein the brace member is rotatably connected to the footing.

8. A stepladder, having a climbing configuration, wherein the stepladder rests on a base surface and is capable of supporting a user, and comprising:
at least a first rail and a second rail, each rail having a base end and a bottom;
at least one rung extending between the first rail and the second rail;
at least one transverse rail having a base end and a bottom and positioned transversely to the first rail and the second rail to support the first rail and the second rail in the climbing configuration; and
at least one footing having a footing length, pivotally attached to the bottom of an associated rail, wherein the footing includes an extended position wherein the footing extends along its footing length rigidly laterally outwardly away from the first rail and the second rail and substantially adjacent to the base surface, and wherein the footing includes a retracted position, wherein the footing extends along its footing length away from the base end of the associated rail and substantially non-adjacent to the base surface;
a brace assembly, for fixedly securing the footing in the rigidly laterally outward position substantially adjacent to the base surface, including:
a brace member rotatably connected to the footing; and
a bracing bracket anchored to the associated rail wherein one end of the brace member is fixedly attached to the bracing bracket to fixedly secure the footing in the rigidly laterally outward position that is substantially adjacent to the base surface.

9. The stepladder of claim 8, wherein the brace member is fixedly attached to the bracing bracket via an aperture in the bracing bracket.

10. The stepladder of claim 8, wherein the brace assembly further includes a securing bracket anchored to the associated rail wherein the securing bracket receives a portion of the brace member therein when the footing extends along its footing length away from the base end of the associated rail and is substantially non-adjacent to the base surface.

11. A stepladder, having a climbing configuration, wherein the stepladder rests on a base surface and is capable of supporting a user, and comprising:
a first rail and a second rail, each rail having a base end and a bottom;
a plurality of rungs extending between the first rail and the second rail;
a first transverse rail and a second transverse rail, each transverse rail having a base end and a bottom, and when in the climbing configuration, the first transverse rail is positioned transversely to the first rail and the second transverse rail is positioned transversely to the second rail;
a first footing having a footing length, pivotally attached to the bottom of the first rail, wherein the first footing includes an extended position wherein the first footing extends along its footing length rigidly laterally outwardly away from the first rail and the second rail and substantially adjacent to the base surface, and wherein the first footing includes a retracted position, wherein the first footing extends along its footing length away from the base end of the first rail and substantially non-adjacent to the base surface;
a first brace assembly, for fixedly securing the first footing in the rigidly laterally outward position substantially adjacent to the base surface, including:
a first brace member rotatably connected to the first footing;
a first bracing bracket anchored to the first rail wherein one end of the first brace member is fixedly attached to the first bracing bracket to fixedly secure the first footing in the rigidly laterally outward position that is substantially adjacent to the base surface; and
a first securing bracket anchored to the first rail wherein the first securing bracket receives a portion of the first brace member when the first footing extends along its footing length away from the base end of the first rail and is substantially non-adjacent to the base surface;
a second footing having a footing length pivotally attached to the bottom of the second rail, wherein the first footing includes an extended position wherein the second footing extends along its footing length rigidly laterally outwardly away from the second rail and the first rail and substantially non-adjacent to the base surface; and wherein the first footing includes a retracted position, wherein the second footing extends along its footing length away from the base end of the second rail and substantially non-adjacent to the base surface;
a second brace assembly, for fixedly securing the second footing in the rigidly laterally outward position substantially adjacent to the base surface, including:
a second brace member rotatably connected to the second footing;
a second bracing bracket anchored to the second rail wherein one end of the second brace member is fixedly attached to the second bracing bracket to fixedly secure the second footing in the rigidly laterally outward position that is substantially adjacent to the base surface; and
a second securing bracket anchored to the second rail wherein the second securing bracket receives one end of the second brace member when the second footing extends along its footing length away from the base end of the second rail and is substantially non-adjacent to the base surface.

12. The stepladder of claim 11, wherein the first footing and the second footing each extend rigidly laterally outward along the base surface.

13. The stepladder of claim 11, wherein the retracted position of the first footing is adjacent to the outside of the first associated rail and wherein the retracted position of the second footing is adjacent to the outside of the second associated rail.

14. A retractable stabilizer support for attachment to a rail of a stepladder for providing lateral support to the stepladder, wherein the stepladder rail includes a base end that rests on a base surface, and the retractable stabilizer support comprises:
a footing including a footing length and a pivot mount wherein the pivot mount is mountable to the stepladder rail such that the footing can be pivoted from an extended position to a retracted position wherein, in the extended position, the footing extends along its footing length rigidly laterally outwardly away from the stepladder rail and substantially adjacent to the base surface and, in the retracted position, the footing extends along its footing length away from the base end of the stepladder rail and substantially adjacent to the stepladder rail.

15. The retractable stabilizer support of claim 14, further comprising a brace assembly for fixedly securing the footing in its extended and retracted positions.

16. The retractable stabilizer support of claim 14, further comprising a brace assembly wherein the brace assembly further includes:
a brace member rotatably connected to the footing wherein the brace member secures the footing in the rigidly laterally outward position substantially adjacent to the base surface.

17. The retractable stabilizer support of claim 14, further comprising a brace assembly wherein the brace assembly further includes:
a brace member rotatably connected to the footing; and
a bracing bracket to be mounted on the stepladder rail and for receiving one end of the brace member to fixedly secure the first footing in the rigidly laterally outward position substantially adjacent to the base surface.

18. The retractable stabilizer support of claim 14, further comprising a brace assembly wherein the brace assembly further includes:
a brace member rotatably connected to the footing; and
a securing bracket to be mounted on the stepladder rail and for receiving a portion of the brace member to secure the footing away from the base end of the stepladder rail and substantially adjacent to the stepladder rail.

19. A retractable stabilizer support for attachment to a rail of a stepladder for providing lateral support to the stepladder, wherein the stepladder rail includes a base end that rests on a base surface, and the retractable stabilizer support comprises:
a footing including a footing length and a pivot mount wherein the pivot mount is mountable to the stepladder rail such that the footing can be pivoted from an extended position, wherein the footing extends along its footing length rigidly laterally outward away from the stepladder rail and substantially adjacent to the base surface, to a retracted position, wherein the footing extends along its footing length away from the base end of the stepladder rail and substantially adjacent to the stepladder rail; and
a brace assembly for fixedly securing the footing in its extended and retracted positions and including:
a brace member rotatably connected to the footing wherein the brace member secures the footing in the rigidly laterally outward position substantially adjacent to the base surface;
a bracing bracket having a receiving aperture and to be mounted on the stepladder rail such that the receiving aperture receives one end of the brace member to fixedly secure the first footing in the rigidly laterally outward position substantially adjacent to the base surface; and
a securing bracket having a receiving section and to be mounted on the stepladder rail such that the receiving section receives a portion of the brace member to secure the footing away from the base end of the stepladder rail and substantially adjacent to the stepladder rail.

20. The retractable stabilizer support of claim 19, wherein the bracket member is an “L” shaped pole.

21. The retractable stabilizer support of claim 19, wherein the bracket member is rotatably attached to the footing by a clasp member.

22. A method of stabilizing a stepladder, wherein the stepladder includes a first rail and a second rail, each rail having a base end and a bottom, a rung extending in a lateral direction between the first and second rail, a transverse rail having a base end and a bottom and positioned transversely to the first and second rail to support the first and second rail in a climbing configuration; and a footing having a footing length and pivotally attached to a base end of an associated rail, and wherein the stepladder is in the climbing configuration resting on a base surface, the method comprising the steps of:
rotating the footing, that extends along its footing length, from a position substantially adjacent to the associated rail to a position extending rigidly laterally outward from the side of the associated rail substantially adjacent to the base surface; and
locking the footing, that extends along its footing length, in the position extending rigidly laterally outward from the side of the associated rail substantially adjacent to the base surface by fixedly securing the brace assembly between the footing and the associated rail.

23. The method of claim 14, wherein the brace assembly includes a brace member rotatably connected to the footing, and a bracing bracket anchored to the associated rail wherein the bracing bracket receives one end of the brace member when the footing is in the position extending rigidly laterally outward from the side of the associated rail substantially adjacent to the base surface, and wherein the step of locking the footing further comprises the step of:
securing an upper end of the brace member to the bracing bracket to fixedly secure the footing, that extends along its footing length, in the position extending rigidly laterally outward from the side of the associated rail substantially adjacent to the base surface.

24. The method of claim 14, wherein the brace assembly includes a brace member rotatably connected to the footing, and a securing bracket anchored to the associated rail wherein the securing bracket receives one end of the brace member when the footing is in a position wherein the footing extends along its footing length away from the base end of the associated rail and substantially non-adjacent to the base surface, and wherein the step rotating the footing further comprises the step of:
releasing an upper end of the brace member from the securing bracket to allow the footing to rotate away from the position wherein the footing extends along its footing length away from the base end of the associated rail and substantially non-adjacent to the base surface and towards the position wherein the footing extends along its footing length laterally outward from the side of the associated rail substantially adjacent to the base surface.
